(19) United States
(12) Patent Application Publication
(10) Pub. No.: US 2020/0098253 A1
(43) Pub. Date: Mar. 26, 2020

(54) PROCEDURE AND APPARATUS FOR CONTROLLING A TRAFFIC MANAGEMENT SYSTEM

(71) Applicant: SMEV AG Smart Mobility Evolution, Frankfurt/Oder (DE)

(72) Inventors: Wolf Peter Zeplin, Meerbusch (DE); Ludwig Trostel, Garching (DE)

(21) Appl. No.: 16/141,795

(22) Filed: Sep. 25, 2018

(51) Int. Cl. G08G 1/087; G08G 1/005; G08G 1/01; G05D 1/00; G05D 1/02; G08G 1/081; G01C 21/34; G01C 21/36

(52) U.S. Cl. CPC G08G 1/087; G08G 1/005; G08G 1/0145; G05D 1/0022; G05D 2201/0212; G08G 1/081; G01C 21/3407; G01C 21/362; G05D 1/0088; G05D 1/028

(57) ABSTRACT

A procedure for influencing a traffic management system including providing position data of a destination for at least one emergency vehicle; providing the current position data and the data of the current travel direction vector of at least one emergency vehicle; predicting a route for at least one emergency vehicle from its current position to the position of the destination, taking into account the direction of travel selected by the driver of the emergency vehicle and represented by the direction of travel vector; influencing an autonomous vehicle with respect to a projected direction of travel on the forecast route in such a way that the respective autonomous vehicle has changed and/or changes its direction of travel and/or its driving speed before or on the predicted arrival of at least one emergency vehicle in such a way that traffic in the direction of the forecast route is not obstructed.

### TECHNICAL FIELD

The invention is directed to methods and systems for controlling a traffic network which includes autonomous vehicles, and more specifically to the priority control of emergency vehicles through the traffic network.

### BACKGROUND OF THE INVENTION

Especially in metropolitan areas, traffic density is constantly increasing, and traffic congestion occurs frequently, not only at peak times. For the drivers of emergency vehicles with right of way, such as police vehicles, fire or rescue service vehicles, this not only means a high level of stress, but also significantly extends the journey times for such vehicles with right of way to their deployed location. In addition, when traffic congestion is high, the risk also increases that an emergency vehicle with right of way will collide with other vehicles with right of way when passing crossroads or junctions.

### STATE OF THE TECHNOLOGY

It has therefore already been proposed several times that emergency vehicles with right of way should not only be granted right of way on their way to the deployed location by using special signals (blue light, siren), but also that traffic alternating light signal systems (traffic lights) should be switched to “free travel” (green) when the emergency vehicle approaches.

DE 28 55 625 A1 shows and describes an arrangement for controlling variable traffic light systems, in which a radio signal can be emitted from the vehicle to activate the variable traffic light system. Such an arrangement requires, however, that both the vehicle and the corresponding variable-mode traffic light systems or switchgear associated with them must be equipped with corresponding radio transmitters and radio receivers, which requires complex technical measures and results in high costs.

DE 195 08 043 C1 shows and describes a control arrangement for traffic signals in which an emergency vehicle is provided with a transmitter unit via which coordinates of the location of the emergency vehicle determined by means of a navigation receiver provided in the emergency vehicle are transmitted to a traffic light computer which determines the direction and speed of the approaching emergency vehicle and, when the emergency vehicle approaches a traffic light, switches this traffic light to green in the direction of travel.

DE 196 01 024 A1 contains a system for optimizing the driving times of vehicles with special rights, in which the position data determined by a navigation receiver in the emergency vehicle is transmitted via a radio link to a traffic control computer, which then switches to phased traffic lights creating a green wave for the driving distance of the emergency vehicle. It is also proposed that the direction of travel and the opposite direction of the emergency vehicle should be cleared of traffic ahead of time by switching on a red wave which congests traffic at one traffic light each in order to obtain a clear lane behind the traffic light. A traffic control computer is defined there in such a way that the traffic control computer coordinates individual local traffic control computers, which in turn control the traffic lights.

DE 198 42 912 A1 shows and describes a procedure for clearing routes for emergency vehicles with special authorization, whereby the position data of the emergency vehicle determined by means of a navigation receiver are regularly transmitted telemetrically from the emergency vehicle to an emergency control center. In the emergency vehicle, the currently determined local coordinates of the emergency vehicle are compared with the coordinates of light signal systems of the corresponding territory stored in a computer in the emergency vehicle. All light signal systems on the way to the scene of action are preselected in this computer and, depending on the driving speed of the emergency vehicle, advanced warning signals are sent to traffic lights located in front of the emergency vehicle in the direction of travel, whereby these traffic lights located on the route of the emergency vehicle are brought into standby mode. The traffic lights located directly in front of the emergency vehicle then receive a main message signal, which causes the traffic lights to switch to “free travel”. This procedure makes it possible that even short-term changes in the direction of travel of the emergency vehicle (e.g. selection of an alternative route to the scene of the incident) are immediately available for switching to a green wave without requiring computing resources from a traffic control computer. However, the disadvantage is that the emergency vehicle must be equipped with a computer with considerable computing power and must also have a database of the traffic lights provided in the local road topology in always up-to-date form.

DE 10 2011 107 881 A1 shows and describes a procedure and a system for optimizing rescue routes for emergency vehicles. The position of an emergency vehicle is periodically recorded and fed to a central location determination system located outside the vehicle, which determines a suitable route for the emergency vehicle with knowledge of the destination. Based on the expected route of the emergency vehicle determined in this way, the traffic lights in front are then switched to a “green wave”. If the route of the emergency vehicle is changed, the determining device then adjusts the way points or the expected route of the emergency vehicle and influences the traffic lights ahead on this new route. In addition to influencing the traffic light switching, traffic participants on the route in front of the emergency vehicle are also signaled on guidance panels that an emergency vehicle is approaching. It is also mentioned that road users are warned at an early stage and can clear the paths accordingly, e.g. a junction in city traffic.

EP 2 618 320 A1 shows and describes a traffic control system for clearing a route for an emergency vehicle. The current location data of an emergency vehicle is transmitted to an operations center, which plans an operational route based on this location data of the emergency vehicle and the known destination and transmits the corresponding route data to a traffic computer center. The traffic computer center then switches the traffic lights along the route to a “green wave”. When the emergency vehicle has left the originally determined operational route, the operational route can be adjusted by the operations control center and thus the route clearing can be changed by the traffic control center. In this way, a route-dependent and dynamic connection of the release phases to the light signals is achieved.

US 2005/0104745 A1 shows and describes a traffic light control system for emergency vehicles, in which an emergency vehicle approaching an intersection communicates directly with the traffic lights at the intersection in order to affect a corresponding clearance.

The post-published DE 10 2014 114 535 A1 shows and describes a procedure for controlling light signal systems at traffic junctions on the route of an emergency vehicle. The emergency vehicle transmits a request signal which is received by a light signal system located within the vehicle environment. This light signal system then switches from normal operation to a priority operation, which grants the emergency vehicle free travel at the traffic junction at which this signal system is provided. In this regard, reference is made to patent claim 1, first and second line item of this reference. The emergency vehicle therefore has a direct influence on the traffic lights in front of it on its route.

### SUMMARY OF THE INVENTION

The task of the present invention is to specify a procedure for influencing a traffic control system for the purpose of priority control for at least one emergency vehicle with right of way, in which the equipment expenditure in the emergency vehicle and in the traffic control system as well as in the variable light sign systems is minimized. At the same time, the technical solution to be specified shall take into account the presence and movement of autonomous vehicles in the implementation of priority control and ensure that an emergency vehicle with right of way reaches the scene of deployment as quickly as possible and at least largely without obstruction by such vehicles even in a traffic area in which autonomous vehicles are located.

Furthermore, it should be avoided that alternating light signal systems have to be individually equipped with radio receivers and their own computers. A further aim of the present invention is to specify such a procedure, in which the guarantee of free travel for the emergency vehicle is further improved in order to enable even shorter travel times to the scene of action. Finally, it is a task of the present invention to identify a device for carrying out such a procedure and to create a computer program product for carrying out such a procedure.

This method for influencing a traffic control system having at least one central traffic control computer which controls at least one autonomous vehicle in a traffic network, for example the traffic network of a city or a district, is carried out for the purpose of priority control for at least one emergency vehicle with right-of-way, the influencing of the traffic control system being carried out on the basis of current position data and a direction vector of at least one emergency vehicle in order to accelerate the latter's journey on a forecast route.

The procedure consists of the following steps:
a) providing position data of a destination for at least one emergency vehicle;
b) providing the current position and direction vector data of at least one emergency vehicle;
c) predicting a travel route for at least one emergency vehicle from its current position to the position of the destination, taking into account the travel direction selected by the driver of the emergency vehicle and represented by the travel direction vector;
d) influencing the autonomous vehicle moving in the projected direction of travel on the forecast route of travel in such a way that the respective autonomous vehicle changes or has changed its speed of travel and/or its direction of travel before or at the predicted meeting with at least one emergency vehicle in such a way that the traffic in the direction of the forecast route of travel, in particular the emergency vehicle, is not obstructed by the autonomous vehicle.
   The invention provides for this,
      in that the current position data and the travel direction vector (R′) of at least one emergency vehicle (2) are transmitted directly or indirectly to autonomous vehicles which are located on the projected travel route (B) of the emergency vehicle (2), and
      that these autonomous vehicles are made to clear the roadway of the forecast route or not to use it at all.

According to the invention, the current position data and the direction vector of at least one emergency vehicle are transmitted directly or indirectly to autonomous vehicles located on the forecast route of the emergency vehicle, in addition to being transmitted to the traffic control computer or to a computer functionally connected to the traffic control computer. This causes these autonomous vehicles to clear the roadway required for at least one emergency vehicle or not to drive on it at all. Autonomous vehicles, i.e. motor vehicles which take part in road traffic without a driver or at least without a driver actively controlling the vehicle at least temporarily, i.e. which drive or hold the vehicle autonomously without a driver at least temporarily, are thus informed at an early stage and independently of their own onboard sensors of the approach of at least one emergency vehicle and made to clear the roadway to be kept clear for at least one emergency vehicle or not to drive on it at all. For example, such an autonomous vehicle can be automatically switched to a prioritized driving mode upon receipt of this information from the approaching emergency vehicle, in which it automatically drives to the nearest edge of the road and remains there, provided that sensors of the autonomous vehicle detect a free lane width next to the vehicle that is greater than a specified width required for the passage of emergency vehicles.

The inventive procedure differs from the state of the art discussed above in that it not only creates a linear green wave along the intended route of the emergency vehicle, but also influences variable message systems in the vicinity of the intended or forecast route of at least one emergency vehicle. This influencing of the alternating light systems not directly affecting the intended direction of travel of the emergency vehicle in a preceding section of the route and in its vicinity in accordance with the invention has the effect that the corridor in the direction of travel in front of the emergency vehicle is cleared. At the same time, it prevents vehicles from entering the traffic corridor while the emergency vehicle is there and possibly blocking it.

Figuratively speaking, at least one emergency vehicle on its forecast route not only formally receives a green wave, but also essentially receives a clear traffic corridor as a result of the priority control in accordance with the invention by shifting an effective area of this priority control along the forecast route and, if necessary, to the left and right of it in front of it, in which, in addition to the green wave for at least one emergency vehicle, a flow of traffic out of the traffic corridor along the forecast route is caused by corresponding switching of the alternating light signal systems. This effective area in front of the emergency vehicle forms a “cloud” of influenced alternating light signal systems and can therefore also be described as a “green cloud”.

The range of this effective area is preferably not static but adapted to the road topology along the forecast route and/or to the current traffic volume. In its smallest extent, for example, the effective area can only include the traffic lights at a road crossing to be crossed. At intersections of multi-lane roads with several turn-off lanes and a correspondingly complex traffic light circuit, the effective area can be selected more widely in order to cover all alternating light signal systems in the large area of the intersection. However, the effective range can also be extended, for example, to variable message systems in secondary roads and/or at laterally adjacent intersections, if this is required by the traffic routing or the traffic flow.

Such a priority control, adjustable in terms of its area of effect, can also be described as a “dynamic green cloud”.

Because the traffic management system is influenced not only by taking into account the current position data of at least one emergency vehicle, but also by its direction vector, the driver of the emergency vehicle is not bound to a fixed external route but can choose his own route depending on the situation and the traffic situation on route. The effective area (“green cloud”), which the emergency vehicle virtually pushes in front of it, then moves with the direction vector of the emergency vehicle.

The invention-based priority control is not limited to alternating light signal systems for traffic on a road network but can include any type of alternating light signal system in a traffic network, for example also signals of a railway network and/or barriers and light signal systems at level crossings of the same type. For example, signals for rail vehicles can also be switched to STOP in order to enable at least one emergency vehicle to pass a railway crossing without danger.

It is of great advantage if, in the same way as at least one autonomous vehicle, the alternating light signals located on the forecast route of the emergency vehicle are switched in such a way that the route of the emergency vehicle is cleared.

In an advantageous version of the invention, the current position data and the direction vector of at least one emergency vehicle are transmitted indirectly to autonomous vehicles via at least one central telematics computer to which the autonomous vehicles are connected for data transmission.

It can also be advantageous if the current position data and the direction vector of at least one emergency vehicle are transmitted directly from the emergency vehicle to autonomous vehicles. Thus, the path of this information is not routed via the central traffic control computer but from the emergency vehicle directly or via the telematics computer to the autonomous vehicles, whereby a faster flow of information can be achieved.

According to a further special design of the invention, in a step d′) carried out during or before step d), further alternating light signal systems in the vicinity of the alternating light signal systems located in front of the emergency vehicle and relating to a projected direction of travel on the forecast route are switched in such a way that in a traffic corridor for at least one emergency vehicle on the roadway of the forecast route, vehicles can leave the corridor and no vehicles can enter the corridor until at least one emergency vehicle reaches this location. The traffic corridor corresponds to the roadway or the area of the roadway or at least the lane along the forecast route required for the safe, fast passage of at least one emergency vehicle.

It is particularly advantageous if the alternating light signal systems are switched in the projected direction of travel on the forecast route in such a way that vehicles in oncoming traffic and/or cross traffic or vehicles willing to turn off in the traffic corridor can leave the corridor before at least one emergency vehicle has reached this location. This clears the traffic corridor well in advance of the arrival of the emergency vehicle.

It is also advantageous if the alternating light signal systems are switched in the projected direction of travel on the forecast route in such a way that vehicles of the cross traffic or of the turn-off traffic cannot enter the traffic lane until at least one emergency vehicle has passed this location. This prevents vehicles from entering the traffic corridor.

In a further development of the procedure according to the invention, the release of the traffic in the direction of the forecast route takes place in such good time before the projected arrival of at least one emergency vehicle at the respective alternating light signal system relating to the projected direction of travel on the forecast route, depending on the traffic density on the forecast route, that vehicles standing in the traffic corridor can start moving and stationary traffic has thus changed into flowing traffic upon the arrival of at least one emergency vehicle.

This further development of the procedure makes it possible for existing traffic jams to dissolve at least to such an extent that the vehicles formerly standing in the traffic jam set themselves in motion and out of this motion can quickly form a rescue lane for at least one emergency vehicle.

It is also advantageous if the alternating light signal systems are switched along the forecast route in such a way that light signals for pedestrians or cyclists are switched to STOP, for example by displaying a red light, at an intersection where the projected direction of travel of the forecast route of at least one emergency vehicle turns into an intersecting road, so that pedestrian traffic and/or bicycle traffic via the intersecting road is stopped. This enables at least one emergency vehicle to turn off quickly without having to stop because of pedestrian or cyclist traffic. This also reduces the risk of turning accidents with the emergency vehicle.

Steps b) to d) and d′) are preferably repeated at time intervals, preferably permanently. Such a recursive execution of the procedure enables a dynamic priority circuit that is adapted to the current route and speed of at least one emergency vehicle.

It is particularly advantageous if the current position data and the data of the current direction vector of at least one emergency vehicle are provided in step b) on an emergency computer, preferably a mobile terminal, which is carried by an authorized person as an occupant of at least one emergency vehicle, and if this data is transmitted to the traffic control computer together with authentication data of this authorized person. Such an emergency computer may be easily installed or retrofitted in an emergency vehicle.

A mobile solution using a mobile terminal device, on the other hand, makes it unnecessary to equip every eligible emergency vehicle with the appropriate hardware and software to carry out the procedure according to the invention, thus saving considerable costs. Only a few mobile end devices, such as tablet computers or mobile phones (smartphones), are still required on which software implementing the procedure (“app”) is stored in executable form. As a rule, the emergency services are equipped with such mobile devices, so that no additional hardware is required.

It is particularly advantageous if the route for at least one emergency vehicle is also forecast on the emergency computer using navigation software running on it, and if the data representing the forecast route is transferred directly from the emergency computer to the traffic control computer. As a rule, smartphones and tablet computers are already equipped with navigation software stored on them so that the purchase of separate navigation systems can be avoided.

The device for carrying out the procedure in accordance with the invention comprises a traffic guidance system (usually already existing) which has at least one traffic control computer and a large number of alternating light signal systems in a traffic network, the traffic control computer controlling the alternating light signal systems in the traffic network. The apparatus, which forms a system for influencing a traffic guidance system, also has at least one emergency vehicle with right of way, whose journey on a forecast route is to be accelerated by means of the method. In addition, at least one position data transmitter and one travel direction vector data transmitter and a transmitter connected to these transmitters for data transmission are provided for the position data and the data of the current travel direction vector, and at least one traffic control computer or a computer functionally connected to the traffic control computer is connected to a receiver for the position data and the travel direction vector data for data transmission. A computer program which executes at least step d) and step d′) of the procedure according to the invention is stored on at least one traffic control computer or on the computer functionally connected to the traffic control computer. Method step c) can be carried out in the on-board mobile terminal and/or in the traffic control computer or in the computer functionally connected to the traffic control computer.

This apparatus allows in a particularly advantageous way the implementation of the procedure according to the invention, whereby only a corresponding hardware and software has to be on board the emergency vehicle, which is able to determine the position and direction data and to transmit them to the traffic control computer or to the computer functionally connected to the traffic control computer. The traffic control computer or the computer functionally connected to the traffic control computer itself only requires additional software in order to influence the traffic light control along the forecast route of at least one emergency vehicle and in the “green cloud” area on the basis of the data transmitted by the emergency vehicle. The individual alternating light signal systems themselves do not have to be equipped with additional hardware or software, which keeps the costs for the operator of the traffic network low.

It is particularly advantageous if the position data transmitter and the direction vector data transmitter as well as the transmitter connected to these transmitters for data transmission are intended for use in an emergency computer, preferably a portable mobile terminal. This allows the cost advantages described above to be achieved by exploiting existing smartphones.

It is advantageous if navigation software is stored on the deployment computer in such a way that it can be run, with which a forecast route between the current position and a given destination can be determined, and if the deployment computer is designed to transmit the data representing the forecast route to the traffic control computer or the computer functionally connected to the traffic control computer by means of the transmitter. On the one hand, a navigation program already present in a smartphone, for example, can be used and, in addition, the traffic control computer or the computer functionally connected to the traffic control computer is not burdened with the navigation calculation.

For this purpose, the computer program product comprises a first computer program which executes step b) and which can be stored in executable form on an emergency computer, preferably a mobile terminal, on the side of the operating vehicle, a second computer program which executes steps d) and d′) and which can be stored in executable form on a traffic control computer or on a computer functionally connected to a traffic control computer, wherein the first computer program and/or the second computer program are adapted to perform step c), and wherein the first computer program and the second computer program are adapted to communicate with each other for the purpose of data transmission, preferably in encrypted form via a radio link secured against manipulation.

Such a computer program product thus consists essentially of two parts, namely a first part, which is stored executable in a corresponding computer device on board the emergency vehicle, and a second part, which is stored executable in the traffic control computer or in a computer functionally connected thereto. The part of the computer program product intended for the emergency vehicle may, for example, be an app that runs on a mobile terminal or in a vehicle navigation system of the emergency vehicle. For the part of the computer program product assigned to the traffic control computer, for example, an independent program layer can be provided in a multi-layer model of traffic control software.

### BRIEF DESCRIPTION OF THE DRAWINGS

Preferred examples of the invention with additional design details and further advantages are described and explained below with reference to the following drawings.

FIG. 1 is a schematic block diagram representation of the method according to the invention.

FIG. 2 is a topology of a section of an inner-city road network that is part of the traffic network.

FIG. 2A is a first detailed presentation of FIG. 2.

FIG. 2B is a second detailed presentation of FIG. 2.

FIG. 3 is a detailed presentation of FIG. 2 with a preceding autonomous vehicle.

### DETAILED DESCRIPTION OF PREFERRED EMBODIMENTS

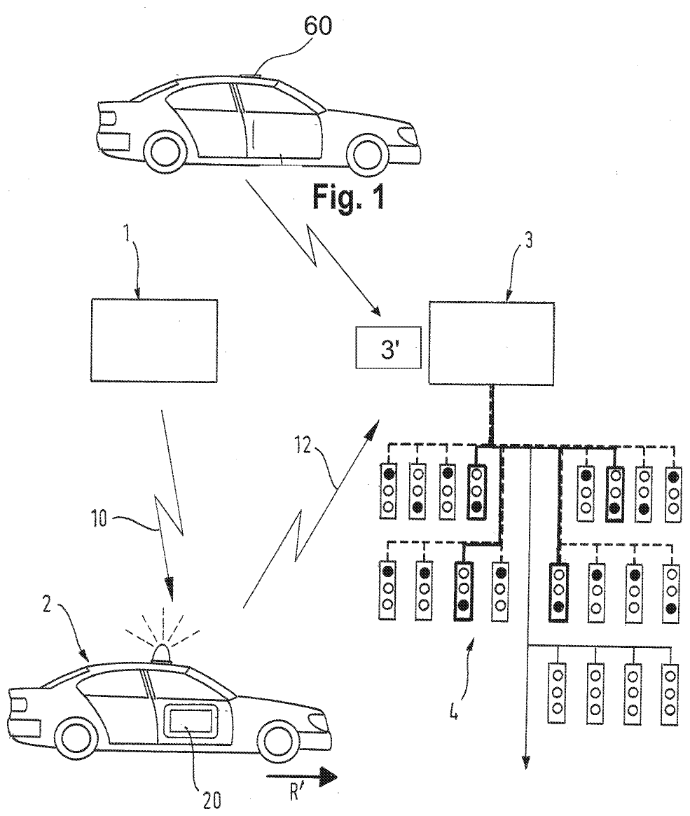

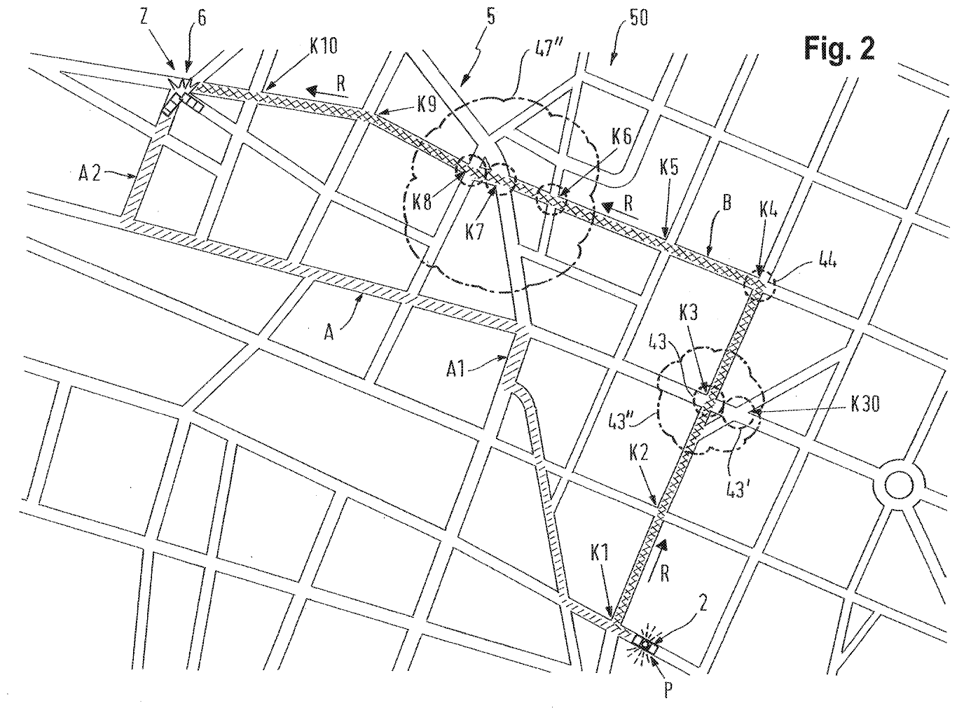

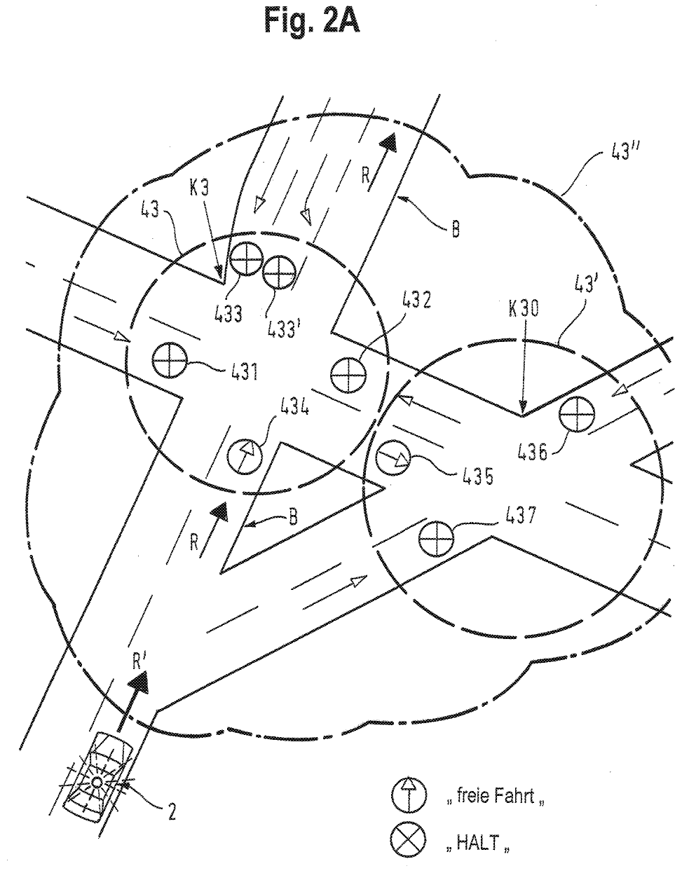

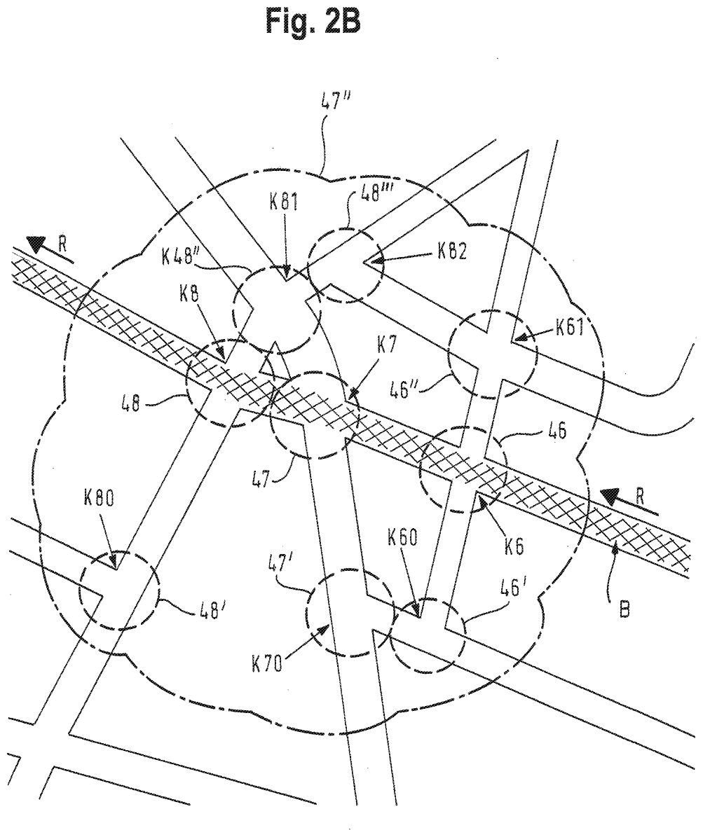

FIG. 1 shows a greatly simplified schematic structure of a system for influencing a traffic control system for the purpose of priority control for an emergency vehicle with right of way. The essential components of this system comprise a control center 1, at least one control vehicle 2, at least one central traffic control computer 3, a plurality of alternating light signal systems 4 which are connected to the central traffic control computer 3 and are provided in a traffic network 5 (FIG. 2) which is controlled by the traffic control computer 3 in order to regulate the flowing traffic, and at least one autonomous vehicle 60 which moves automatically in the traffic network 5 without a driver actively controlling the autonomous vehicle.

The emergency vehicle 2 moves in this traffic network 5, as described below in connection with FIG. 2.

In the event of a deployment, the emergency vehicle 2 or the emergency personnel in the emergency vehicle 2 receives a deployment order from the operations center 1 with the data of the location 6 (FIG. 2), i.e. the destination Z for the emergency vehicle 2. These data are transmitted, for example, via a first radio link 10 from the operations center 1 to the emergency vehicle 2. On board the emergency vehicle 2 there is an emergency computer 20, which receives the information transmitted via the radio link 10 about the location 6 and the destination Z. This computer 20 is used for the transmission of data from the control center to the emergency vehicle 2. This mission computer 20 can be permanently installed in the emergency vehicle 2, but preferably the mission computer 20 is a tablet computer or a mobile radio device, such as a smartphone, on which an operation computer program runs. In addition, the mission computer 20 has a position data transmitter and a direction vector data transmitter as well as a transmitter connected to these transmitters for data transmission.

The emergency computer 20 is equipped with navigation software or has access to a navigation computer located on board the emergency vehicle 2 in order to determine the current position P of the emergency vehicle 2 as well as its direction vector R′. Furthermore, the navigation software or the navigation device calculates a proposal for a route from the current location of the emergency vehicle to the destination Z on the basis of the known destination data.

After receiving the command, the emergency computer 20 on board of the emergency vehicle 2 reports its current position P and its current direction vector R′, together with the authentication data authorizing the operation, encrypted by means of the built-in transmitter at regular intervals or at irregular intervals depending on speed, via a second radio link 12 secured against manipulation to the traffic control computer 3 equipped or connected with a corresponding receiver. The data on the forecast route determined on board the emergency vehicle 2 is also transmitted to the traffic control computer 3 in the same way as data on a “forecast route” via the second radio link 12. Alternatively, the new forecast route can also be determined on the traffic control computer 3.

After the authentication information has been checked by the traffic control computer 3, it influences the relevant driving data of the autonomous vehicles on this route or in the vicinity along the projected driving route for the projected driving direction R of the emergency vehicle 2. For this purpose, the current position data and the travel direction vector of at least one emergency vehicle 2, in addition to being transmitted to the traffic control computer 3 or to a computer functionally connected to the traffic control computer 3, are transmitted directly or indirectly to at least one autonomous vehicle 60 located on the projected travel route of the emergency vehicle 2. This causes the autonomous vehicle(s) 60 to clear the lane required for at least one emergency vehicle 2 or not to drive on it at all. Autonomous vehicles 60, i.e. motor vehicles which participate in road traffic without a driver or at least without a driver at least temporarily actively controlling the vehicle, i.e. at least temporarily driving or holding the vehicle autonomously without a driver, are thus informed at an early stage and independently by their own onboard sensors of the approach of at least one emergency vehicle 2 and induced to clear the roadway to be kept clear for at least one emergency vehicle 2 or not to drive on it at all. In this way an autonomous vehicle 60 will be automatically switched to a prioritized driving mode upon receipt of this information from the approaching emergency vehicle 2, in which it automatically drives to the nearest edge of the road and remains there, provided that sensors of the autonomous vehicle 60 detect next to the vehicle a free roadway width which is greater than a predetermined width required for the passage of emergency vehicles 2.

Furthermore, after the authentication information has been checked by the traffic control computer 3, the alternating light signal systems relevant for the projected driving direction R of the emergency vehicle 2 along the projected driving route are influenced by the traffic control computer 3 in such a way, in particular switched, that the respective alternating light signal system releases the traffic in the direction of the projected driving route before or upon the forecast arrival of the emergency vehicle 2, thus switching a green wave for the projected driving direction R of the emergency vehicle 2 along the projected driving route. This influencing of the individual alternating light signal systems to form a green wave is symbolized by the thicker connecting lines between the traffic control computer 3 and some of the alternating light signal systems (shown with a thick border) of the numerous 4 alternating light signal systems shown in FIG. 1.

Before or parallel to the above described creation of a green wave for the emergency vehicle 2, further alternating light signal systems in the vicinity of the alternating light signal systems located in front of the emergency vehicle 2 and relating to the direction of travel of the forecast route are switched (green or red) in such a way that in a traffic corridor for at least one emergency vehicle located on the roadway of the forecast route, the vehicle can leave the traffic corridor before the emergency vehicle 2 reaches this location. These can be, for example, vehicles of oncoming traffic, cross traffic or vehicles in the traffic corridor that are stationary or want to turn. In addition, this additional traffic influence may prevent vehicles from entering the traffic corridor until at least one emergency vehicle has passed this area. This additional influence on the alternating light signal systems in the vicinity is symbolized in FIG. 1 by dashed thick connecting lines between the traffic control computer 3 and individual alternating light signal systems of the numerous 4 alternating light signal systems of the traffic network 5. Other alternating light signal systems of the traffic network 5 controlled by the traffic control computer 3 are not influenced by the priority control.

The manner in which such priority control for at least one emergency vehicle is carried out by influencing alternating light signal systems in the vicinity of the alternating light signal systems directly affecting the direction of travel is explained below using FIG. 2.

FIG. 2 schematically shows the topology of a road network 50 which is part of an urban traffic network 5. In addition to the road network 50, the traffic network 5 can also include, for example, the network of inner-city trams as well as a network of public transport buses travelling in their own lanes and, if required, even railway lines leading through the road network 50. The task of the emergency vehicle 2 is to travel from its current location P at the lower edge of FIG. 2 to an emergency location 6 at the upper left edge of the picture, where, for example, a traffic accident occurred. This location 6 also represents the destination Z for the emergency vehicle.

The navigation computer on board the emergency vehicle 2 determines the diagonally crosshatched route A as the shortest route to location 6. However, this route A has two critical sections for the rapid progress of the emergency vehicle 2, namely section A1, where the emergency vehicle has to turn right from a side road into a main road and a little later has to turn left at an intersection. In this main street, for example, the rails of a tram run on the roadway and there is a tram stop in this area. The driver of the emergency vehicle 2 knows this weak point and knows that he must expect a delay of his journey here. Furthermore, the driver of emergency vehicle 2 suspects that a traffic jam has already occurred in section A2 of route A, i.e. the road leading to the scene of the accident, due to the high volume of traffic that regularly occurs there.

The driver of the emergency vehicle 2 therefore decides to turn off at the next junction K1 and to choose the crosshatched alternative route B. When the emergency vehicle 2 turns off at junction K1, the navigation system on board the emergency vehicle 2 or the navigation software running on the emergency computer 20 registers the change of direction of the emergency vehicle 2 and reports the current position data and the data of the new direction vector R′ to the traffic control computer 3. A new forecast route B for the emergency vehicle 2 is determined and this new forecast route data is also transmitted to the traffic control computer 3. The traffic control computer 3 therefore knows that the emergency vehicle 2 will soon pass the intersection K2 and switches the traffic lights for the projected direction R of the emergency vehicle 2 to green. The traffic lights for the projected direction R of the emergency vehicle 2 at the following intersection K3 are also switched to green.

However, the K3 intersection area has a complex traffic management system, as there is another K30 intersection right next to the K3 intersection, which is also traffic-light controlled. Here, traffic jams often occur in front of the alternating light signal systems at intersection K30, which extend into intersection K3. Therefore, it is not sufficient to switch the variable traffic light systems of intersection K3, which affect the projected direction of travel R of the emergency vehicle 2, to green; instead, it must be ensured beforehand that the traffic backed up into intersection K3 before the variable traffic light system of intersection K30 can clear the intersection K3.

For this purpose, as shown in the significantly enlarged FIG. 2A, the alternating light signal systems 431, 432, which control the cross-traffic flowing into intersection K3, are switched to “STOP”, which is symbolized by a circle with a cross. If left-hand turning is permitted at intersection K3 on the road in the projected direction R, oncoming traffic travelling straight ahead is also stopped by means of the alternating light signal system 433. This allows left turners to leave the lane of the projected direction of travel R and clear it for the emergency vehicle 2. The alternating light signal system 433′, which is switched to “STOP”, also stops the left turn traffic from the opposite direction leading over the lane of the projected driving route B, while the alternating light signal system 434, which affects the driving direction R of the emergency vehicle 2 on the projected driving route B, is switched to “free travel”, which is symbolized by the straight ahead arrow in the circle. In this way, group 43 of the alternating light signal system, which directly affects intersection K3, is switched in such a way that no traffic flow blocks the lane of the forecast route R of the emergency vehicle 2 into intersection K3 and waiting vehicles which may be in the corridor on the lane of the forecast route R can leave the corridor.

In the present case, however, control of group 43 of alternating light signal systems directly at intersection K3 is not sufficient, since the immediately adjacent intersection K30 with group 43′ of alternating light signal systems at intersection K3 has a negative influence on traffic to the extent that there are often backlogs in cross traffic which extend as far as intersection K3. In the area of intersection K3, the inventive influence of the alternating light signal systems by the traffic guidance system is now extended beyond group 43 of alternating light signal systems to group 43′ of alternating light signal systems of the adjacent intersection K30.

The range of action 43″ of the priority control is therefore extended from group 43 of alternating light signal systems affecting intersection K3 to group 43′ of alternating light signal systems assigned to the adjacent intersection K30. This takes place in such a way that the traffic leading out of intersection K3 can flow off via intersection K30 through the alternating light signal system 435 of the adjacent intersection K30, which is switched to “free travel”, so that intersection K3 is cleared. The alternating light signal systems 436 and 437 of group 43′, which control cross-traffic with respect to the aforementioned outgoing traffic, are switched to “STOP” for this purpose.

In this way, the effective area 43″ of the alternating light signal systems from intersection K3 to intersection K30 is extended by including two groups 43, 43′ of alternating light signal systems in the special control system for giving priority by the traffic control computer 3. The described control of the alternating light signal systems of group 43′ ensures a flow of traffic out of intersection K3 and the described control of the alternating light signal systems of group 43 prevents further flow of traffic into intersection K3, so that intersection K3 is cleared upon arrival of the emergency vehicle 2 and the emergency vehicle 2 can cross intersection K3 without a significant reduction in its speed due to traffic.

If the emergency vehicle 2 has crossed the intersection K3, it must turn left at the following intersection K4. The traffic control computer 3 is aware of this turn request due to the forecast route B, so that the traffic control computer can switch group 44 of the alternating light signal systems at intersection K4 accordingly. For this purpose, not only the alternating light signal systems of group 44 are switched to “STOP” for cross traffic, but the alternating light signal systems for oncoming traffic and pedestrian traffic are also switched to “STOP”, so that only the alternating light signal system relating to the route of the emergency vehicle is switched to “free travel”. The emergency vehicle can thus turn left at intersection K4 without reducing its speed due to traffic. At the following intersection K5, a green wave for the emergency vehicle 2 is switched again as already described.

The following intersections K6, K7 and K8 on the forecast route B of the emergency vehicle 2 are part of a topologically more complex road system with a large number of intersections and junctions located next to the forecast route B, which are also equipped with alternating light signal systems. In a similar way as has been described in connection with the control of the alternating light signal systems of the operating range 43″ around intersections K3 and K30, a larger operating range 47″ is defined in the area of intersections K6, K7 and K8, which comprises the groups of alternating light signal systems located in this area, namely group 46 of intersection K6 with groups 46′ and 46″ of intersections or junctions K60 and K61 adjacent to intersection K6, intersection K7 with its group 47 and group 47′ of intersection K70 adjacent to intersection K7 and group 48 of intersection K8 and group 48″ at intersection K80 adjacent to intersection K8 and groups 48″ and 48″″ of intersection K8 adjacent to intersection K81 and subsequent intersection K82. In this area of operation 47″, the alternating light signal systems located here are also controlled in order to prevent traffic from flowing into the corridor on the roadway of the forecast route B and at the same time to ensure that vehicles located in the corridor on the roadway along the route B in the direction of travel R of the emergency vehicle 2 can leave this roadway.

At the two subsequent intersections K9 and K10 it is again sufficient to influence only the alternating light signal systems of the respective intersections K9 and K10 and to switch a green wave for the emergency vehicle.

The inventive method of influencing a traffic management system thus ensures that at least one emergency vehicle not only finds a green wave along its forecast route, but also finds a traffic corridor free of traffic jams, stationary cross traffic, waiting turning traffic, etc., so that the emergency vehicle can drive at a significantly higher speed than before and thus reach the scene of the emergency more quickly. At the same time, the accident risk for the emergency vehicle is reduced, as there are no or hardly any “disturbing” vehicles in the corridor cleared for the emergency vehicle 2.

The traffic situations described in which the application of the inventive procedure results in an acceleration of the deployment of at least one emergency vehicle 2 and a reduction of the accident risk are only given as examples. Of course, the inventive procedure can also be used for many other traffic situations and local topologies of traffic networks, whereby the core idea of the invention is implemented each time, in addition to switching a “green wave” for the emergency vehicle 2 by corresponding switching of the alternating light signal systems in the area of an intersection or road junction or even a railway crossing and even in the vicinity thereof, to significantly influence the traffic from the arrival of the emergency vehicle, that the traffic corridor in the projected direction of travel R of the emergency vehicle 2 is cleared or empty before the arrival of the emergency vehicle 2 and that entry into the traffic corridor is prevented at the same time. As a result, the emergency vehicle not only finds the “green wave” when approaching, but also an open corridor.

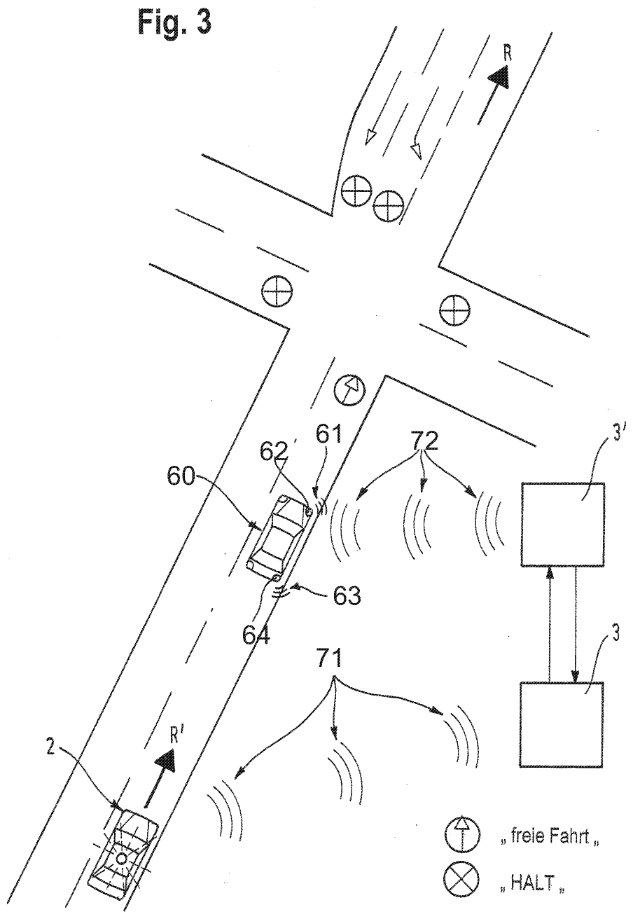

FIG. 3 shows a situation in which an autonomous vehicle 60 is driving in front of the emergency vehicle 2 in the projected direction of travel R. This autonomous vehicle 60 takes part in road traffic without a driver. As shown symbolically by the radio distance symbols 71, 72, the position data and the direction of travel vector R′ are transmitted indirectly from the emergency vehicle 2 to autonomous vehicles 60 ahead. In the example shown, the data is first transmitted via radio link 71 from the emergency vehicle 2 to the traffic control computer 3, from which a signal is sent to a computer 3′ functionally connected to the traffic control computer 3, which in turn sends a signal to the autonomous vehicle 60 in front, which is then informed of the approach of the emergency vehicle 2. The autonomous vehicle 60 is then automatically switched to a prioritized driving mode in which it automatically moves to the nearest edge of the road, as represented symbolically by the symbolized flashing signals 61, 63 of the right-hand direction indicators 62, 64 of the autonomous vehicle 60. Previously, sensors of the autonomous vehicle 60 next to the vehicle 60 detected a free lane width greater than a specified width required for the passage of emergency vehicles 2.

It goes without saying that the invention is not limited to a priority control for a single emergency vehicle but can also be used for a number of emergency vehicles, for example a group of fire engines. It is also a matter of course that in a network of roads in which a number of emergency vehicles with right of way are travelling at the same time, precautions are taken to prevent two emergency vehicles approaching an intersection or junction from different directions from simultaneously receiving a green traffic light in their respective direction of travel.

Reference signs in the claims, the description and the drawings serve only for a better understanding of the invention and should not limit the scope of protection.

### REFERENCE LIST

The following are referenced:
1 operations center
2 emergency vehicle
3 traffic control computer
3′ additional computer
4 numerous alternating light signal systems
43 alternating light signal system
43′ alternating light signal system
43″ effective area of the priority control
431 alternating light signal system
432 alternating light signal system
433 alternating light signal system
433′ alternating light signal system
434 alternating light signal system
435 alternating light signal system
436 alternating light signal system
437 alternating light signal system
44 alternating light signal systems group
46 alternating light signal systems group
46′ alternating light signal systems group
46″ alternating light signal systems group
47 alternating light signal systems group
47′ alternating light signal systems group
47″ effective area
48 alternating light signal systems group
48′ alternating light signal systems group
48″ alternating light signal systems group
48″′ alternating light signal systems group
5 traffic network
6 deployed location
10 first radio link
12 second radio link
20 emergency computer
50 road network
60 autonomous vehicle
61 63 flashing signals
62 64 right side direction indicator signal
71 72 radio range symbols
A driving route
A1 section driving route
A2 section driving route
B driving route
K1 intersection
K2 intersection
K3 intersection
K4 intersection
K5 intersection
K6 intersection
K7 intersection
K8 intersection
K9 intersection
K10 intersection
K30 intersection
K60 road junction
K61 road junction
K70 road junction
K80 road junction
K81 intersection
K82 road junction
P position
R projected driving direction
R′ travel direction vector
Z destination

1. A process for influencing a traffic management system with a traffic control computer (3), which controls at least one autonomous vehicle (60) in a traffic network (5), for the purpose of a priority control for at least one emergency vehicle (2) with right of way, wherein the influencing of the traffic management system takes place on the basis of current position data and a direction vector (R′) of at least one emergency vehicle (2) in order to accelerate its travel on a projected travel route, the process comprising the steps of:
a) providing position data of a destination (Z) for at least one emergency vehicle (2);
b) providing the current position data and the data of the current travel direction vector (R′) of at least one emergency vehicle (2);
c) predicting a route for at least one emergency vehicle (2) from its current position to the position of the destination (Z), taking into account the direction of travel selected by the driver of the emergency vehicle (2) and represented by the direction of travel vector (R′);
d) influencing the autonomous vehicle (60) moving in a projected direction (R) on the forecast route in such a way that the respective autonomous vehicle has changed its route and/or its driving speed before or on the projected arrival of at least one emergency vehicle (2) in such a way that it does not obstruct traffic in the direction of the forecast route,
wherein:
the current position data and the direction of travel vector (R′) of at least one emergency vehicle (2) are transmitted directly or indirectly to autonomous vehicles which are on the forecast route (B) of the emergency vehicle (2), and that these autonomous vehicles are made to clear the lane of the forecast route or not to use it in the first place.

2. The process according to claim 1, wherein the transmission of the current position data and the direction of travel vector (R′) of at least one emergency vehicle (2) to autonomous vehicles takes place indirectly via at least one central telematics computer to which the autonomous vehicles are connected for data transmission.

3. The process according to claim 1, wherein the current position data and the direction of travel vector (R′) of at least one emergency vehicle (2) are transmitted to autonomous vehicles directly from the emergency vehicle.

4. The process according to claim 1, wherein the traffic control computer (3) controls the numerous (4) alternating light signal systems in the traffic network (5) for the purpose of priority control for at least one emergency vehicle (2) with right of way, the traffic control system being influenced on the basis of current position data and a direction vector (R′) of at least one emergency vehicle (2) in order to accelerate its travel on a forecast route, which includes:
d′) influencing the alternating light signal system concerning a projected direction of travel (R) on the forecast route in such a way that the respective alternating light signal system releases traffic in the direction of the forecast route before or on the projected arrival of at least one emergency vehicle (2).

5. The process according to claim 4, further comprising a step d′) carried out during or before step d) further alternating light signal systems are switched in the vicinity of the alternating light signal systems located in front of the emergency vehicle (2) and affecting the projected driving direction (R) on the forecast driving route such that in a driving corridor for at least one emergency vehicle on the lane of the forecast driving route vehicles can leave the driving corridor and no vehicles can drive into the driving corridor until at least one emergency vehicle reaches this location.

6. The process according to claim 4, wherein the alternating light signal systems are switched in the projected direction (R) of travel on the forecast route in such a way that vehicles of oncoming traffic and/or cross-traffic or vehicles planning to turn in the corridor can leave the driving corridor before at least one emergency vehicle (2) has reached this location.

7. The process according to claim 4, wherein the alternating light signal systems are switched in the projected direction (R) of travel on the forecast route in such a way that vehicles of transverse traffic or of turning traffic cannot drive into the corridor until at least one emergency vehicle (2) has passed this location.

8. The process according to claim 4, wherein the release of the traffic in the direction of the forecast route is effected in dependence on the traffic density on the forecast route so in time before the projected arrival of at least one emergency vehicle (2) at the respective alternating light signal system concerning the projected direction (R) of travel on the forecast route that vehicles standing in the corridor can start moving and thus stationary traffic has changed into flowing traffic on arrival of at least one emergency vehicle (2).

9. The process according to claim 4, wherein the alternating light signal systems are switched along the forecast route in such a way that at a road junction, at which the projected direction (R) of travel of the forecast route of at least one emergency vehicle (2) turns into an intersecting road, light signs for pedestrians or cyclists are switched to STOP, for example by displaying a red light, so that pedestrian traffic and/or bicycle traffic is stopped via the intersecting road.

10. The process according to claim 4, wherein steps b) to d) and d′) are repeated in time intervals, preferably permanently.

11. The process according to claim 4, wherein the provision of the current position data and the data of the current travel direction vector (R′) of at least one emergency vehicle (2) in step b) takes place on an emergency computer (20), preferably a mobile terminal, which an authorized person carries along as occupant of at least one emergency vehicle (2), and in that this data is transmitted together with authentication data of this authorized person to the traffic control computer (3).

12. The process according to claim 11, wherein the route for at least one emergency vehicle (2) is also predicted on the emergency computer (20) by means of navigation software running thereon, and in that the data representing the forecast route is transmitted from the mobile terminal (20) to the traffic control computer (3).

13. An apparatus for carrying out the procedure according to one of the preceding claims, having a traffic management system with at least one traffic control computer (3) and numerous (4) alternating light signal systems in a traffic network (5), the traffic control computer (3) controlling the alternating light signal systems in the traffic route network (5),
wherein:
at least one emergency vehicle (2) with right of way, whose travel is to be accelerated on a forecast travel route (B) by means of the procedure, is provided at least one position data transmitter and one travel direction vector data transmitter as well as a transmitter connected to these transmitters for data transmission for the position data and the data of the current travel direction vector,
at least one traffic control computer (3) or a computer functionally connected to the traffic control computer (3) is connected to a receiver for the position data and the travel direction vector data for data transmission, and
a computer program which executes at least steps d) and d′) of the procedure in accordance with one of the preceding claims is stored on at least one traffic control computer (3) or the computer functionally connected to the traffic control computer.

14. The apparatus according to claim 13, wherein the position data transmitter and the direction of travel vector data transmitter and the transmitter connected to these encoders for data transmission are provided in an operating computer (20), preferably a portable mobile terminal.

15. The apparatus according to claim 14, wherein a navigation software is stored on the deployment computer (20) so that it is possible to determine a forecast route between the current position and a predetermined destination (Z), and in that the deployment computer (20) is designed to transmit the data representing the forecast route of travel by means of the transmitter to the traffic control computer (3) or the computer functionally connected to the traffic control computer (3).

16. A computer program product for performing a process according to claim 1, the program comprising:
a first computer program which executes step b) and which can be executed and stored on a deployment vehicle-side deployment computer (20), preferably a mobile terminal,
a second computer program which executes steps d) and d′) and which can be stored on a traffic control computer (3) or a computer functionally connected to a traffic control computer (3),
wherein the first computer program and/or the second computer program are adapted to perform step c), and
wherein the first computer program and the second computer program are adapted to communicate with each other for the purpose of data transmission, preferably encrypted via a radio link (12) secured against manipulation.
